(19) United States
(12) Patent Application Publication
(10) Pub. No.: US 2024/0143722 A1
(43) Pub. Date: May 2, 2024

(54) DYNAMIC ENTITLEMENT MANAGEMENT AND CONTROL

(71) Applicant: Bank of America Corporation, Charlotte, NC (US)

(72) Inventors: Malinda Kieffer, Chillicothe, MO (US); James Gambit, La Crescenta, CA (US); Andrzej Grabski, Glen Rock, NJ (US); Susan Moss, Vestal, NY (US); Asha Thekkumpurath, Frisco, TX (US); Govindaiah Simuni, Charlotte, NC (US); Jigar Shah, Franklin Township, NJ (US); Pia Guerin, Mechanicsville, VA (US); Russ Ferguson, Brooklyn, NY (US); Sekhar Dola, Plainsboro, NJ (US)

(21) Appl. No.: 17/978,332

(22) Filed: Nov. 1, 2022

(51) Int. Cl. G06F 21/40

(52) U.S. Cl. CPC G06F 21/40

(57) ABSTRACT

Acting as a proxy on behalf of a co-worker requires software and hardware entitlements to support the co-workers' duties. Such entitlements should be granted timely and maintained as long as the proxy obligations are in force. Because the proxy only accesses the co-worker's entitlements on a need-basis, there is risk that the credentials of the proxy may time-out. Because the proxy only infrequently accesses the co-worker's entitlements, the proxy may not be aware that their credentials to those entitlements have expired. Apparatus and methods for are provide for an artificial intelligence tool for managing and maintaining entitlements and for proxy, primary and secondary access credentials in complex enterprise computing environments. The tool may provide a one-stop web service and associated application for viewing current status of entitlement credentials and autonomously preventing expiration of those credentials based on current and future needs of an individual or organization.

### FIELD OF TECHNOLOGY

This application relates to controlling and managing access to network-accessible software and hardware resources in a complex enterprise computing environment.

### BACKGROUND

Large enterprise organizations may provide their personnel (hereinafter, “user”) with access to various software and hardware resources. These resources may be remotely accessible to users over a network. Illustrative software resources may include database access, word processing, email applications and video conferencing and other software. Illustrative hardware resources may include access to servers and cloud computing environments. Each of these hardware and/or software resources may be referred to herein as an “entitlement.”

Large enterprise organizations may have over 750,000 users each having different access permissions and rights to over 4,000 different entitlements. Each user may have their own credentials for accessing an entitlement. To prevent unauthorized access to an entitlement, a user's credentials may automatically expire if the user does not access a resource within a pre-determined time window. Management of user credentials and associated expiry of those credentials for all a user's entitlements may be managed by an access rights management (“ARM”) computer server.

Automated expiration of user credentials may not pose a technical challenge for entitlements a user accesses on a regular basis. For example, as part of their regular duties, a user may access a specific entitlement multiple times on a daily or weekly basis. Daily or weekly access to the entitlement may be sufficiently frequent to prevent the ARM server from automatically expiring the user's credentials.

However, in large enterprise organizations, users may also have credentials that allow a user to access an entitlement on behalf of one or more colleagues in a secondary or proxy role. For example, a first user may supervise a second user. Both the first and second users may have access credentials to a target entitlement. However, the second user may log on more frequently to the target entitlement than the first user. It is possible for access credentials of the first user to expire despite collaborating and supervising the second user. Thus, if the second user is not available to access the target entitlement, the first user may not be able to access the target entitlement during an ongoing project.

Currently a user must manually monitor the status of each of their access credentials. The user must calendar reminders to ensure that they periodically access an entitlement and maintain active credentials. Users that access multiple entitlements may need to spend an hour or more a month simply logging in to multiple entitlements to ensure their credentials remain active.

Additionally, expiration of credentials may be tracked and controlled by the ARM server. In some scenarios, despite a user regularly logging in to an entitlement, the ARM server may not be synchronized or updated to reflect the user's regular login activity. Thus, despite tracking and duly logging in to a target entitlement, the user's credentials may nonetheless expire. Additionally, the user may not even be aware that their credentials have expired.

The technical challenges of managing credentials for multiple users are exponentially compounded by the large number of users, software applications and computer servers in complex enterprise environments. It is technically challenging to manage the thousands of entitlements and access credentials in such complex enterprise environments. Software and hardware entitlements provide functionality that allow users to efficiently perform tasks needed by the enterprise organization. Therefore, it is important that users have consistent access to entitlements they need to perform their daily tasks.

However, it is also important for security protocols that prevent unauthorized access to those entitlements remain in place. Allowing user to maintain unnecessary access to an entitlement may expose the enterprise organization to an increased risk of a cyberattack on its information systems or other resources. Users who have unnecessary access to entitlements may not be aware that a rarely used entitlement is malfunctioning or behaving erratically. Rarely used entitlements may not be configured appropriately or may not be updated or patched regularly. Additionally, extraneous access credentials create additional exposure points that may be utilized by malicious hackers or other unscrupulous actors.

It would be desirable to apply more efficient and consistent automated tools for managing and controlling access to entitlements in complex enterprise environments. As described herein, DYNAMIC ENTITLEMENT MANGAGEMENT AND CONTROL provides technical solutions for improving the consistency and reliability of access to software and hardware resources in complex enterprise environments.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows an illustrative system in accordance with principles of the disclosure;

FIG. 4 shows operation timing of an illustrative system in accordance with principles of the disclosure;

FIG. 5 shows an illustrative system in accordance with principles of the disclosure;

FIG. 6A shows an illustrative user interface in accordance with principles of the disclosure;

FIG. 6B shows an illustrative user interface in accordance with principles of the disclosure; and

FIG. 7 shows an illustrative user interface in accordance with principles of the disclosure.

### DETAILED DESCRIPTION

Apparatus and methods are provided for a one-stop web service/application that users may access for management and control of entitlements. Methods may include an artificial intelligence (“AI”) method for dynamically managing an entitlement. The entitlement may be a software resource, hardware resource or combination thereof. The method may include extracting computer readable instructions stored on a non-transitory medium and executing the computer readable instructions on a processor of a computer system. Execution of the computer readable instructions by the processor implement the steps of the AI method.

The method may include detecting a first login by a user to access a first target entitlement. Based on the first login, the method may include determining an expiration date when the user will lose access to the first target entitlement. Based on the expiration date, the method may include scheduling a target date for effectuating a second login to access the target entitlement.

The target date may be determined such that if the second login is effectuated by the target date, the user will not lose access to the target entitlement. The second login may maintain access of the user to the target entitlement beyond the expiration date. Methods may include, before the target date, initiating the second login to the target entitlement.

The method may include detecting a third login to the target entitlement. The third login may be performed by the user as a matter of course when performing their usual duties. The third login may occur after the first login and before the target date. In response to detecting the third login, the method may include determining a revised expiration date and a revised target date. The third login may extend the previously determined expiration date. The method may include rescheduling the second login for maintaining the user's credentials for a time after the expiration date and before the revised target date. The second login may be performed by an autonomous system that effects a login that prolongs access of the user to the target entitlement.

The methods may include detecting an assignment of a proxy to access the target entitlement on behalf of a primary user. The proxy may have their own set of credentials for accessing the target entitlement. Before the target date (when credentials of the user are scheduled to expire), the methods may include initiating a third login to the target entitlement on behalf of the proxy. The third login may ensure that both the primary user and the proxy maintain consistent access to the target entitlement.

The target entitlement may be a first target entitlement. The method may include determining a time window when the user must login to both the first target entitlement and a second target entitlement to maintain access to both entitlements. Methods may include determining the time window such that logins to the first and second target entitlements can both be effectuated within the time window and the user will maintain access to both entitlements.

Determining such a time window may reduce the amount of time a user must spend logging in to different entitlements. The methods may determine the time window when the user's credentials are still active for both the first and second target entitlements, yet the user's credentials are also close to being expired such that a login to both entitlements will extend access to both entitlements for a meaningful amount of time. “Close” to being expired may be within a day, a week or month of expiration. A “meaningful” amount of time may refer to maintaining the credentials for at least two weeks after a login date.

Methods may include, during the time window, initiating the second login to the first target entitlement using first credentials. Methods may include, during the time window, initiating a third login to the second target entitlement using second credentials.

Access to functionality provided by the target entitlement may require two-factor authentication. Methods may include effectuating a specialized login that maintains a user's access to a target entitlement. The specialized login may not provide the user with access to functionality provided by the target entitlement. The specialized access may be implemented autonomously. The specialized access may only maintain access of the user to the target entitlement after the expiration date and may not require two-factor authentication.

The methods may include detecting initiation of a threshold number of second logins for maintaining access to a target entitlement. Each of the second logins may be specialized logins that only maintain access of the user to the target entitlement. In response to detecting the threshold number of autonomous logins, methods may include presenting a login screen to maintain access to the target entitlement. As a result of detecting the threshold number of autonomous logins, the login screen may require that the user provide two-factor authentication even to maintain access to the target entitlement.

Methods may include assigning a proxy to access an entitlement on behalf of a user. The assigned proxy may be provided credentials for accessing a target entitlement on behalf of the user. The credentials may allow the proxy to access the target entitlement if a primary user is unavailable. Methods may include autonomously assigning a proxy based on a frequency of email correspondence between the primary user and the proxy.

For example, methods may include monitoring email correspondence of the primary user. The methods may identify a potential proxy based on the inclusion of the proxy in the monitored email correspondence (e.g., in “to” or “cc” lines of an email). The inclusion of the proxy in the email correspondence may indicate that the proxy regularly collaborates with the primary user. Therefore, the methods may determine that the identified proxy may be familiar with projects of the primary user or entitlements regularly accessed by the primary user.

Methods may include determining an expiration date for user credentials based on a first time zone associated with the target entitlement and a second time zone associated with a location of the user. For example, the target entitlement may be physically located in a different time zone than the user. However, the credentials of the user may expire based on local time in the time zone associated with the target entitlement. Methods may include determining an expiration date and a target date based on the time zone of the user's location. Methods may include prompting the user to effectuate the second login needed to maintain credentials during the user's working hours.

After initiating the second login and after the expiration date, methods may include querying an access rights management (“ARM”) system for a timestamp of a most recent entitlement update for the user. If the timestamp on record with the ARM system indicates that the most recent entitlement update for the user was prior to the second login, methods may include submitting a new request for access to the target entitlement.

After effecting the second login, the ARM system should reflect an entitlement update for the user that has a timestamp after the second login. The out-of-date entitlement update on record with the ARM system indicates that the ARM system has not detected or otherwise registered the second login. In such scenarios, to ensure that the user maintains access to a target entitlement, a new access request (e.g., assuming the user's access credentials have expired) is submitted to the ARM system to renew the user's credentials.

An artificial intelligence (“AI”) system for managing an entitlement for a user is provided. The system may include an AI engine. The AI engine may include machine executable instructions (which may be alternatively referred to herein as “computer instructions” or “computer code”), stored in a non-transitory memory of a computer system.

An illustrative computer system may include a workstation, desktop, laptop, tablet, smartphone, or any other suitable computing device. The computer system may be used to implement various aspects of the systems and methods disclosed herein. The computer system may have a processor for controlling the operation of the computer system and its associated components.

The processor may include one or more integrated circuits that include logic configured to process executable instructions associated with the computer system. The processor may compute data structural information and structural parameters of the data. The computer system may include two or more processors.

Illustrative components of the computer system may include RAM, ROM, input/output (“I/O”) devices, and a non-transitory or non-volatile memory. Machine-readable memory may store information in machine-readable data structures. The processor may also execute software running on a computer system. Other components commonly used for computers, such as EEPROM or flash memory or any other suitable components, may also be part of the computer system.

The non-transitory memory may be comprised of any suitable permanent storage technology—e.g., a hard drive. The non-transitory memory may store software including an operating system and application program(s) along with any data needed for the operation of the computer system. Non-transitory memory may also store videos, text, and/or audio files. The data stored in the non-transitory memory may also be stored in cache memory, or any other suitable memory. For example, data may temporarily be stored in ROM or RAM.

Application program(s) may include computer executable instructions (alternatively referred to as “programs”). The computer executable instructions may be embodied in hardware or firmware (not shown). The computer system may execute the instructions embodied by the application program(s) to perform various functions of the AI system. Application program(s) (which may be alternatively referred to herein as “plugins,” “applications,” or “apps”) may include computer executable instructions for invoking functionality related to performing various functions of the AI system.

Application program(s) may utilize the computer-executable instructions executed by a processor. Generally, programs include routines, programs, objects, components, data structures, etc., that perform particular tasks or implement particular abstract data types. Application program(s) may utilize one or more algorithms that process received executable instructions, effectuate logins to an entitlement or other suitable tasks.

Application program(s) may utilize one or more AI algorithms described herein Illustrative AI computational algorithms that may be utilized by the AI engine may include AdaBoost, Naive Bayes, Support Vector Machine, Random Forests, Artificial Neural Networks and Convolutional Neural Networks. Application program(s) used by the computer system may also include computer executable instructions for invoking functionality related to communication, such as e-mail, Short Message Service (SMS), and voice input and speech recognition applications.

Illustrative I/O devices included in the computer system may include a microphone, keyboard, touch screen, mouse, and/or stylus through which input signals may be provided into the computer system. The I/O devices may also include one or more speakers for providing audio output and a video display device for providing textual, audio, audiovisual, and/or graphical output.

The computer system may be connected to other systems via a local area network (“LAN”) interface. The computer system may operate in a networked environment supporting connections to one or more remote computers. Remote terminals may be personal computers or servers that include many or all of the elements described in connection with the computer system. Illustrative network connections may also include a wide area network (“WAN”). When used in a LAN networking environment, the computer system may be connected to a LAN through a LAN interface or an adapter. When used in a WAN networking environment, the computer system may include a modem, antenna or other hardware for establishing communications over WAN to a remote network such as the Internet.

The computing system may be operational with distributed computing environments where tasks are performed by remote processing devices that are linked through a communications network. In a distributed computing environment, an application program may be located in both local and remote computer storage media including memory storage devices. Computing systems may rely on a network of remote servers hosted on the Internet to store, manage, and process data (e.g., “cloud computing” and/or “fog computing”).

It will be appreciated that the network connections described are illustrative and other means of establishing a communications link between computer systems may be used. The existence of various well-known protocols such as TCP/IP, Ethernet, FTP, HTTP and the like is presumed, and the computer system can be operated in a client-server configuration to permit retrieval of data from a web-based server or application programming interface (“API”). Web-based, for the purposes of this application, is to be understood to include a cloud-based system. A web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Components of the computer system may be linked by a system bus, wirelessly or by other suitable interconnections. Components of the computer system may be present on one or more circuit boards. In some embodiments, the components may be integrated into a single chip. The chip may be silicon-based.

The computer system may be a portable device such as a laptop, cell phone, tablet, smartphone, or any other computing system for receiving, storing, transmitting and/or displaying relevant information. The computer system may be operational with numerous other general purpose or special purpose computing system environments or configurations. Examples of well-known computing systems, environments, and/or configurations that may be suitable for use with this disclosure include, but are not limited to, personal computers, server computers, hand-held or laptop devices, tablets, mobile phones, smart phones and/or other mobile devices, multiprocessor systems, microprocessor-based systems, cloud-based systems, programmable consumer electronics, network PCs, minicomputers, mainframe computers, distributed computing environments that include any of the above systems or devices, and the like.

The AI system may include an AI engine that determines a plurality of entitlements associated with a user. The AI engine may determine a level of access that is needed by the user for each of the plurality of entitlements. The AI engine may determine an expiration date for each of the plurality of entitlements. The expiration date may be when the user, absent further any additional action, will lose access to each of the entitlements.

For example, a target entitlement may be configured such that if the user does not login into or otherwise access the target entitlement within 30 days, the user may be locked out of the target entitlement or otherwise prevented from accessing the target entitlement. A user that does not login into a target entitlement at least once in 30 days may lose access to the target entitlement. For example, the user's credentials may expire.

Allowing the user to maintain unnecessary access to the target entitlement may expose the target entitlement to an increased risk of a cyberattack. Users who have unnecessary access to a target entitlement may not be aware that the target entitlement is malfunctioning or behaving erratically. Extraneous access credentials may provide additional exposure points to the target entitlement that may be utilized by malicious hackers or other unscrupulous actors.

Based on the expiration date for each of the plurality of entitlements, the AI engine may formulate a target date for accessing each of the plurality of entitlements to ensure that the user does not lose access to those entitlements. The additional access to each of the plurality of entitlements may maintain the user's access to each of the plurality of entitlements.

The system may include a user interface. The user interface may allow a primary user to assign a proxy to access at least one of the user's entitlements. The proxy may be provided with access credentials for a target entitlement. The access credentials of the proxy may provide access to a workspace or other portal of the primary user. If the primary user is unavailable, the proxy may access the target entitlement and fulfill the duties of the primary user.

The user interface may allow a user to search for a target entitlement. The interface may allow the user to submit a request for access to the target entitlement. The request for access may be submitted to an ARM server. The ARM server may interface between the user and the target entitlement. The ARM server may provide the user interface for managing entitlements.

The ARM server may formulate the access request and create an account for the proxy on the target entitlement. In some embodiments, the ARM server may control expiration of a user account or credentials (e.g., primary or proxy). In some embodiments, the target entitlement itself may control expiration of a user account or credentials.

The user interface may allow a user to authorize the AI engine to effectuate access to each of the plurality of software entitlements before the expiration date for each of the plurality of software entitlements. For example, the user interface may request that the user enter a single set of credentials that authorizes the AI system to autonomously access each of the plurality of software entitlements. Based on the determined expiration dates, the AI system may access each of the software entitlements just before the corresponding expiration date.

The user interface may allow the user to search for co-workers that have access to a target entitlement. The user interface may allow a user to revoke previously assigned proxy access from a first co-worker. The user interface may allow reassignment of proxy access to a second co-worker.

The user interface may integrate with a users' email and calendar applications. For example, the user interface may allow a primary user to assign proxy access to a target entitlement based on an out of office reply set by the primary user. The user interface may allow the primary user to search for other co-workers that are expected to be working during a time the primary user will be out of the office. The primary user may then assign proxy access for a target entitlement to a selected co-worker while the primary user is out of the office.

The user interface may also allow the primary user to revoke previously assigned proxy access based on the out of office reply. For example, the user interface may allow the user to automatically revoke assigned proxy authority when the primary user is expected to return to the office. The user interface may allow the primary user to assign proxy access to a first co-worker for a first-time window and assign proxy access to a second co-worker for a second period of time. For example, the first co-worker may also be out of the office during the second period of time.

A user may provide a single set of user credentials to the AI system to authorize a login to an entitlement. For example, the single set of credentials may be a non-fungible token (“NFT”). Ownership of the NFT may be used to authorize the AI system to login to one or more entitlements and prevent expiration of the user's credentials. In some embodiments, after successfully validating the single set of credentials, the AI system may use its own set of credentials to access an entitlement.

The AI system may not be provided full access to functionality of a target entitlement when logging in to maintain the user's credentials. For example, a login by the AI system may only be sufficient to demonstrate that a user has a continued interest in the target entitlement. However, when the user logins into the target entitlement using their own credentials, the user may be provided full access to functionality of the target entitlement.

The credentials provided to the AI system to authorize a limited access “maintenance” login that prevents expiration of a user's credentials may be a token. The token may be stored locally on a device of the user. The token may be stored on a distributed ledger, such as a Blockchain. For example, the token may be an NFT. The credentials provided to the AI system to authorize a limited access “maintenance” login that prevents expiration of a user's credentials may include a username and password. User credentials for accessing full functionality of an entitlement may include a token. The token may be stored on a distributed ledger, such as a Blockchain. For example, the token may be an NFT. The NFT may identify a target entitlement that is authorized to be accessed with the token.

Ownership of an NFT may be correlated to a private cryptographic key. For example, using the private key, an owner of the NFT may digitally sign or encrypt the NFT. Only a public key paired to the owner's private key will successfully verify the digital signature or decrypt the NFT. A user may prove ownership of the NFT by executing or digitally signing a transaction using the same private key used to digitally sign or encrypt the NFT.

After an expiration date for each of a plurality of entitlements, the AI engine may attempt to access each of the entitlements using a second set of credentials. The second set of credentials may be system credentials of the AI system or AI engine. The AI system may fail to successfully access a target software entitlement using the second set of credentials.

As a result of the failure, user access to a target entitlement may expire. For example, as a result of the failure, user access to a target entitlement may be suspended. In response to detecting the failure, the AI system may submit a request requesting to renew the user credentials for accessing the target entitlement.

As a result of detecting the login failure prior to the expiration date the AI system may be aware that the user's access to the target entitlement will expire on the expiration date. The AI system may submit the request for user access to a centralized rights management system (e.g., ARM server). The AI system may submit the request to the ARM server before the expiration date for the target entitlement. The AI system may submit the request to the ARM server such that the user does not lose access to the target entitlement. The AI system may submit the request with sufficient time (e.g., 7 days in advance of the expiration date) to ensure that the ARM server can process the renewal request before the expiration date.

A system architecture for managing user entitlements in a complex enterprise computing environment is provided. The system architecture may include a first restricted entitlement. The first entitlement may be restricted because only users with a first set of authorized credentials may be allowed to access functionality of the first restricted entitlement. The system architecture may include a second restricted entitlement. The second entitlement may be restricted because only users with a second set of authorized credentials may be allowed to access functionality of the second restricted entitlement.

The system architecture may include a user interface. The user interface may display primary access rights of a first user to the first restricted entitlement. The user interface may display secondary access rights of the first user to the second restricted entitlement. Secondary access rights may allow the first user to access the second restricted entitlement concurrently with the primary user. Secondary access rights may not be coextensive with access rights of the primary user. For example, the secondary access rights may not provide access to certain functionality of the second restricted entitlement.

The user interface may display proxy access rights of a second user to the first restricted entitlement. Proxy access rights may be access rights that are only enabled for the second user when a primary user is unavailable to access the first entitlement. The primary user may not be available to access the first entitlement because credentials of the primary user have expired.

The system architecture may include an artificial intelligence (“AI”) engine. The AI engine may maintain the primary and the secondary access rights of the first user. The AI engine may maintain the primary and secondary access rights by periodically logging into the first and second restricted entitlements on behalf of the first user. The AI engine may maintain the proxy access rights of the second user. The AI engine may maintain the proxy rights by periodically logging into the first and second restricted entitlements on behalf of the second user.

To maintain access rights to an entitlement, the AI engine may autonomously login into the first and/or second entitlements to maintain the primary and the secondary access rights of the first user. The AI engine may autonomously login into the first and/or second entitlements to maintain the proxy access rights of the second user.

The system architecture may include a plugin that integrates the user interface into a virtual assistant application of the first user. The plugin may also integrate the user interface into a second virtual assistant application of the second user. For example, integration with a user's virtual digital assistant application may allow the user interface to show when a user's access credentials are scheduled to expire overlayed over a potential proxy or secondary user's work schedule. The integration may also allow the user interface to display when a user's access credentials to a target entitlement are scheduled to expire overlayed over when a potential proxy or secondary user's credentials to the target entitlement will expire. The information presented by the user interface may allow a user to visually confirm that at least one member of a team always has access to a target entitlement.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown and/or described herein. Method embodiments may omit steps shown and/or described in connection with illustrative methods. Method embodiments may include steps that are neither shown nor described in connection with illustrative methods. Illustrative method steps may be combined. For example, an illustrative method may include steps shown in connection with any other illustrative method.

Apparatus may omit features shown and/or described in connection with illustrative apparatus. Apparatus embodiments may include features that are neither shown nor described in connection with illustrative apparatus. Features of illustrative apparatus may be combined. For example, an illustrative apparatus embodiment may include features shown or described in connection with another illustrative apparatus/method embodiment.

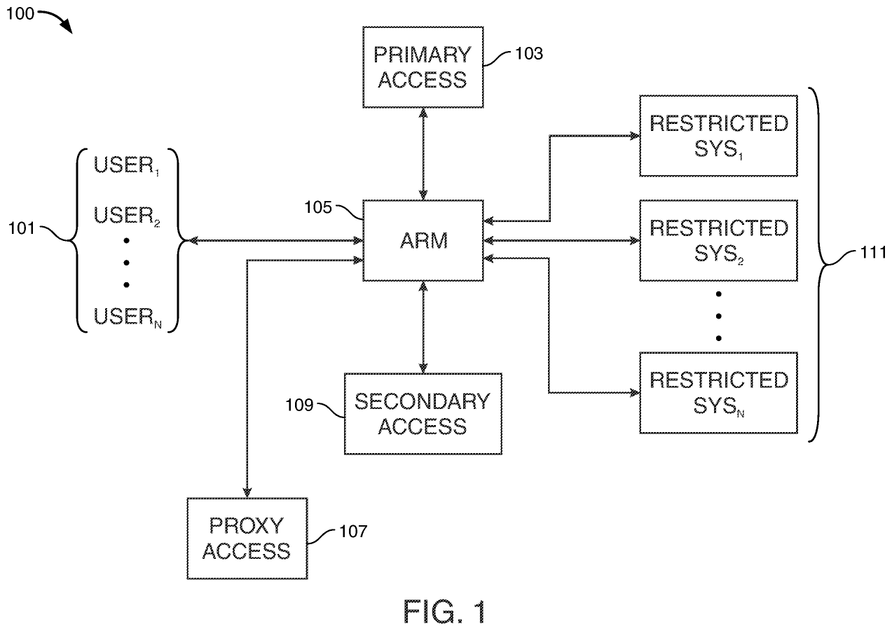

FIG. 1 shows illustrative system 100. System 100 may be accessible to one or more of users 101. In system 100, ARM server 105 manages access of users 101 to restricted entitlements 111. For example, each of users 101 may have access rights and credentials to restricted entitlements 111 that are managed by ARM server 105. FIG. 1 shows that ARM server 105 may manage primary access rights 103. ARM server 105 may manage proxy access rights 107. ARM server 105 may manage secondary access rights 109.

As part of access management, ARM server 105 may expire credentials of users 101. ARM server 105 may expire credentials when a user does not access one of restricted entitlements 111 within 30 days or any other suitable interval. ARM server 105 may set different expiration dates for different levels of access. For example, credentials associated with primary access 103 may expire more frequently than credentials associated with secondary access 109. After access credentials of a user expire, the user must submit a new request to ARM server 105 to renew access credentials to one or more of restricted entitlements 111.

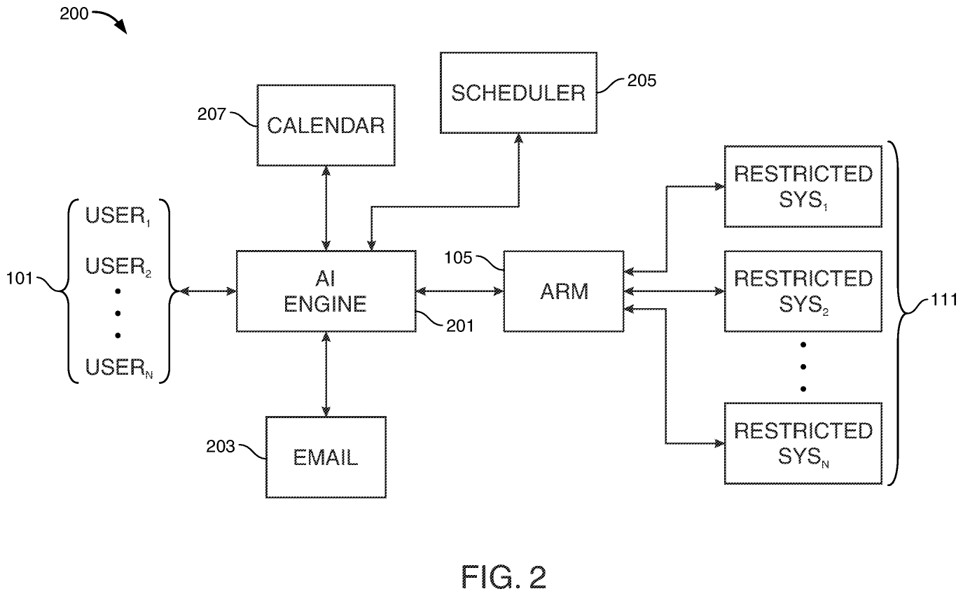

FIG. 2 shows illustrative system 200. System 200 includes AI engine 201. AI engine 201 interfaces between users 101 and ARM server 105. AI engine 201 may manage credentials and access rights of users 101 to one or more of restricted entitlements 111.

AI engine 201 may integrate with one or more virtual digital assistant applications. For example, system 200 shows that AI engine 201 may integrate with email application 203. Based on a primary user's email correspondence, AI engine 201 may identify potential secondary and proxy users for the primary user. AI engine 201 may integrate with calendar application 207. AI engine 201 may present, within calendar application 207, an expected expiration date of a primary user's credentials. AI engine 201 may present, within calendar application 207, an expected expiration date of credentials of secondary and proxy users.

AI engine 201 may integrate with scheduler 205. Scheduler 205 may determine when a user must login into restricted entitlements 111 to avoid expiration of access credentials. Based on login timing determined by scheduler 205, AI engine 201 may access calendar application 207 and create a reminder for one or more of users 101 to login into to restricted entitlements 111. In some embodiments, AI engine 201 may autonomously initiate a login to restricted entitlements 111 based on expiration dates determined by scheduler 205.

When AI engine 201 autonomously initiates a login to restricted entitlements 111, AI engine 201 may display a login screen to users 101. Users 101 will then need to manually input their access credentials into the displayed login screen to successfully effect a login to restricted entitlements 111. In some embodiments, AI engine 201 may autonomously complete a login to restricted entitlements 111 on behalf of users 101. AI engine 201 may access a token or other credentials of users 101 and effect the autonomous login to restricted entitlements 111.

Based on the autonomous login effected by AI engine 201, access credentials of users 101 may not expire on an expiration date. The autonomous login by AI engine 201 may prevent ARM server 105 from registering that users 101 have not accessed restricted entitlements 111 within 30 days or any other suitable interval set for expiration of user credentials.

FIG. 200 shows that AI engine 201 interacts with restricted entitlements 111 via ARM server 105. Access to restricted entitlements 111 may require presentation and validation of unexpired user credentials. In other embodiments (not shown), AI engine 201 may interact directly with restricted entitlements 111 and bypass ARM server 105.

AI engine 201 may detect that an expiration date determined by scheduler 205 has passed without users 101 logging into one or more of restricted entitlements 111. AI engine 201 may submit an access request to ARM server 105. In some embodiments, AI engine 201 may only submit the access request to ARM server 105 on behalf of a secondary or proxy user. For such secondary or proxy users, the expiration of credentials may likely be due to an oversight because such secondary or proxy users do not regularly login to restricted entitlements 111. However, for a primary user, who is expected to regularly login to restricted entitlements 111, AI engine 201 may require submission of an access request to ARM server 105 if the primary user's access credentials have expired.

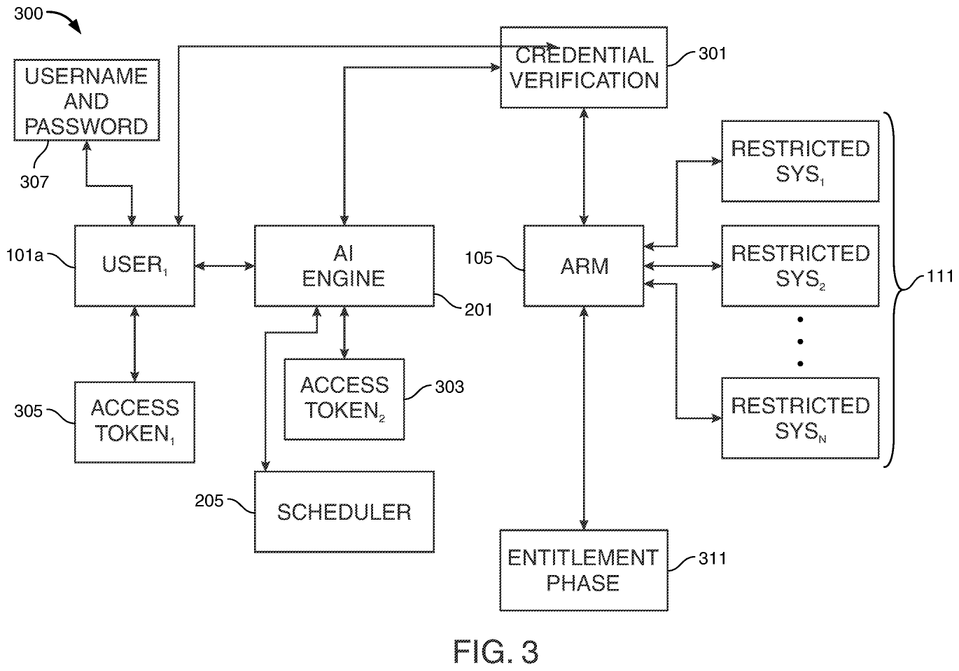

FIG. 3 shows illustrative system 300. System 300 shows operational interaction of AI engine 201 and ARM server 105. AI engine 201 monitors credentials 307 of user 101a (one of users 101, shown in FIG. 1). Credentials 307 may be presented by user 101a to access one or more of restricted entitlements 111.

AI engine 201 may interact with ARM server 105 and determine an expiration date for credentials 307. The expiration date may be when credentials 307 will expire if user 101a does not login to restricted entitlements 111 prior to the expiration date. Entitlement database 311 may track and store logins of user 101a into restricted entitlements 111. Entitlement database 311 may track expiration dates associated with one or more of users 101.

AI engine 201 may present an expiration date to user 101a. AI engine 201 may request that user 101a authorize AI engine 201 to autonomously effect a login into one or more of restricted entitlements 111 to prevent expiration of credentials 307. In response to the request from AI engine 201, user 101a may provide token 305.

Token 305 may be stored locally on a device of user 101a. Token 305 may be stored on a distributed ledger, such as a Blockchain. For example, token 305 may be an NFT. The NFT may identify one or more of restricted entitlements 111 that are authorized to be accessed based on token 305.

Credential verification module 301 may be used to authenticate token 305. Credential verification module 301 may utilize public-private key cryptography to verify token 305. Public-private cryptography utilizes a private and public key pair to perform authentication. The private key may be secured by user 101a and kept secret. User 101a may use the private key to create token 305. For example, token 305 may be a digital signature generated by a private key of user 101a.

Credential verification module 301 may authenticate token 305 by verifying the digital signature created using the private cryptographic key of user 101a. Token 305 may be a public cryptographic key paired to the private key of user 101a. If credential verification module 301 successfully verifies token 305 using token 303 presented by AI engine 201, credential verification module 301 may determine that user 101a has authorized AI engine 201 to autonomously login to one or more of restricted entitlements 111.

Based on the expiration date determined by scheduler 205, AI engine 201 may utilize scheduler module 205 to calculate a target date for effectuating the login needed to avoid expiration of credentials 307. The target date may be prior to the expiration date. The target date may be sufficiently earlier than the expiration date such that if (e.g., because of a malfunction), ARM server 105 does not timely push updates to restricted entitlements 111, AI engine 201 may submit a request to ARM server 105 to renew credentials 307 before they expire.

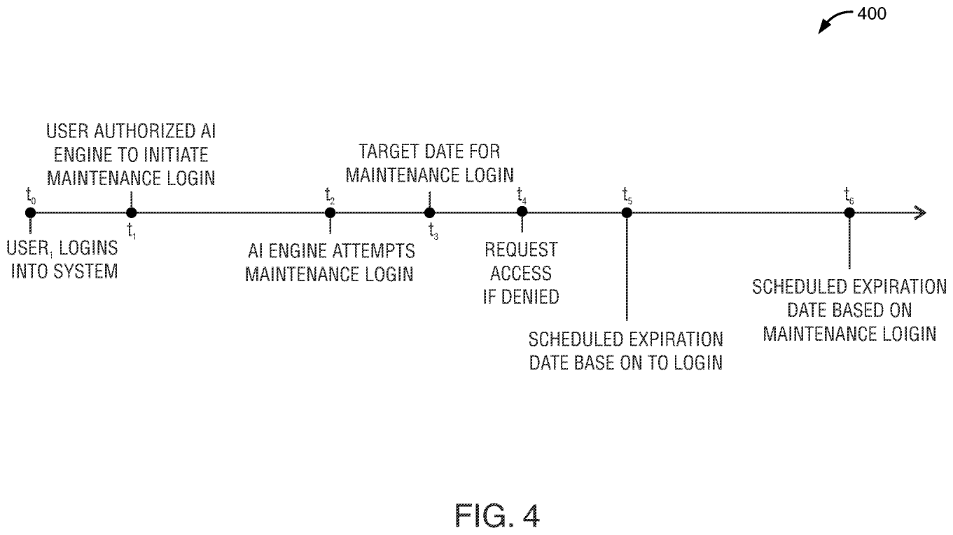

FIG. 4 shows an illustrative sequence 400 of operational steps associated with system 300 (shown above in FIG. 3). Sequence 400 shows that at to, user 101a logs into one or more of restricted entitlements 111. AI engine 201 may determine that based on the login at to, to prevent expiration of credentials 307, a “maintenance” login to one or more of restricted entitlements 111 must be effected on behalf of user 101a no later than the expiration date t₅. Based on determining expiration date t₅, AI engine 201 may schedule the maintenance login to ensure that credentials 307 do not expire at t₅. AI engine 201 may utilize scheduler 205 to determine when the maintenance login should be attempted such that credentials 307 remain non-expired at least until t₆.

Based on calculated date t₆, at t 1 user 101a authorizes AI engine 201 to autonomously initiate a login to maintain and prevent expiration of credentials 307 at t₅. AI engine 201 may prompt user 101a for authorization to effect the maintenance login. At t₂ (prior to expiration date t₅), AI engine 201 attempts to login to restricted entitlements 111 on behalf of user 101a.

At t₄, AI engine 201 may check whether entitlement database 311 records that credentials 307 are associated with the maintenance login at t₂. If AI engine 201 determines that despite the maintenance login effected at t₂ credentials 307 are still associated with expiration date t₅, AI engine 201 may submit a request to ARM server 105 to renew credentials 307. The renewal request submitted to ARM server 105 may force an update to database 311. In some embodiments, the request submitted to ARM server 105 may be a request to renew credentials 307.

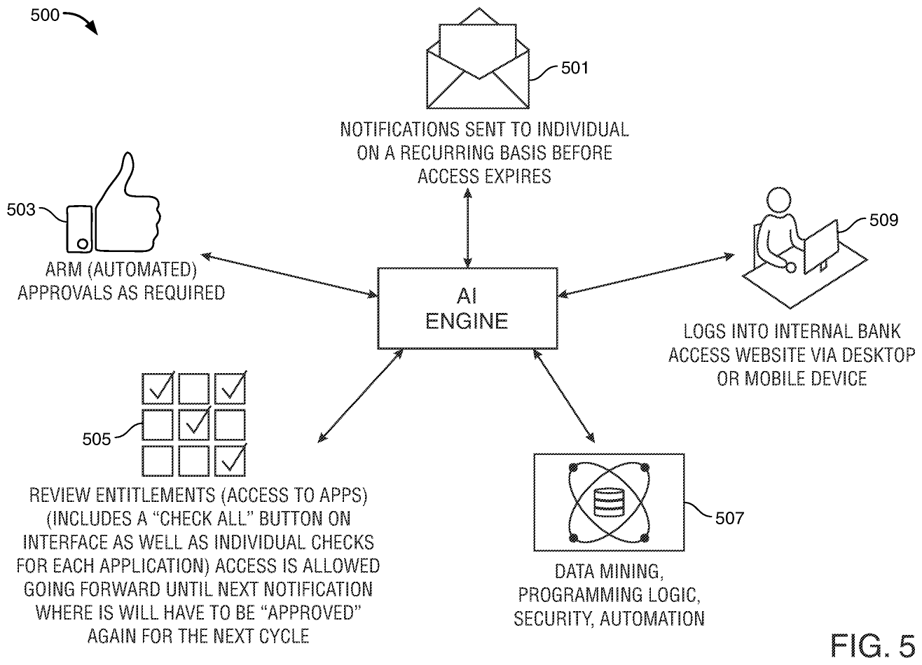

FIG. 5 shows illustrative functionalities 500 of AI engine 201. Functionalities 500 include notifications 501. Notifications 501 may be sent to one or more of users 101 on a recurring basis before an expiration date. Notifications 501 may remind user of impending the expiration date and that a maintenance login should be effectuated to prevent expiration of their credentials. Functionalities 500 include automated ARM server approvals 503. Automated ARM approvals 503 may include autonomous maintenance logins initiated by AI engine 201.

Functionalities 500 includes user interface 505. User interface 505 allows users 101 to review their entitlements (access to software/hardware resources). User interface 505 allows users 101 to customize settings for maintenance logins effectuated by AI engine 201.

For example, user interface 505 may include a “check all” button to instruct AI engine 201 to maintain credentials associated with all a user's entitlements. User interface 505 may allow users 101 to select individual entitlements that will be autonomously maintained by logins initiated by AI engine 201 and select other entitlements for manual maintenance logins.

User interface 505 may also allow users 101 to elect to allow a set of credentials to expire. For example, one or more of users 101 may have been assigned secondary or proxy access and may not be available to fulfill those duties. User interface 505 may also display an expected time when credentials for a target entitlement are scheduled to expire. User interface 505 may show when credentials were last renewed because of a user login.

Functionalities 500 include automated features 507. Automated features 507 may include AI algorithms for assigning access rights to a user. The AI algorithms may determine when to login to restricted entitlements 111 so that a user's credentials remain active in accordance with a user's assigned responsibilities. Illustrative AI algorithms utilized by AI engine 201 may include application of machine learning techniques, such as AdaBoost, Naive Bayes, Support Vector Machine, Random Forests, Artificial Neural Networks, Deep Neural Networks and Convolutional Neural Networks.

Functionalities 500 may include providing users 101 access 509 to expiration dates, scheduling and entitlements across any user device or system. Access 509 may be provided across workstations, desktops, cloud computing environments, laptops, tablets, smartphones, or any other computing environment. Users 101 may therefore view, change and maintain their entitlements and associated credentials regardless of device or operating environment currently being used.

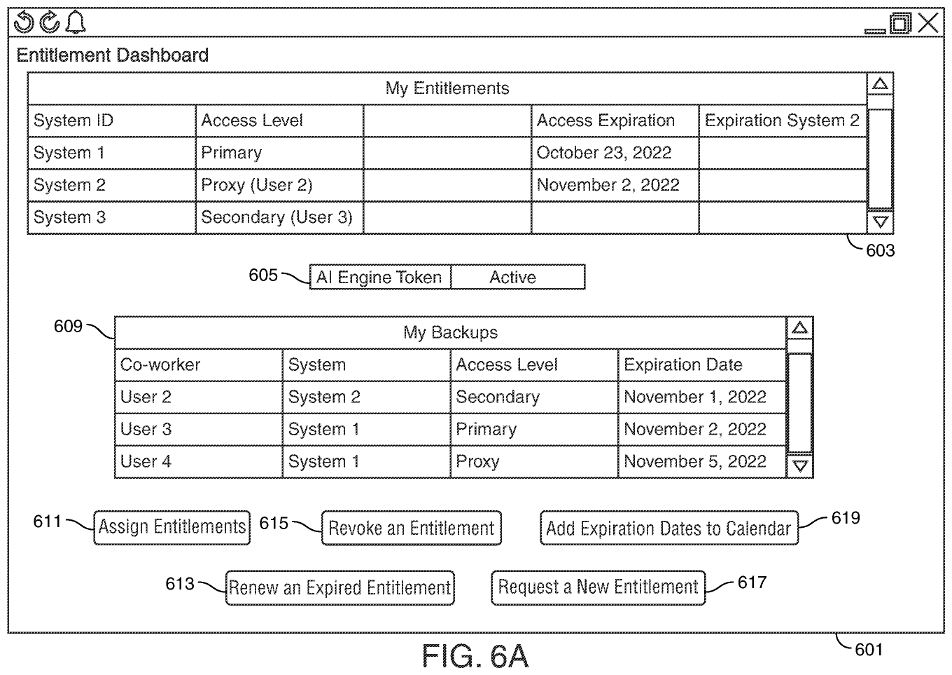

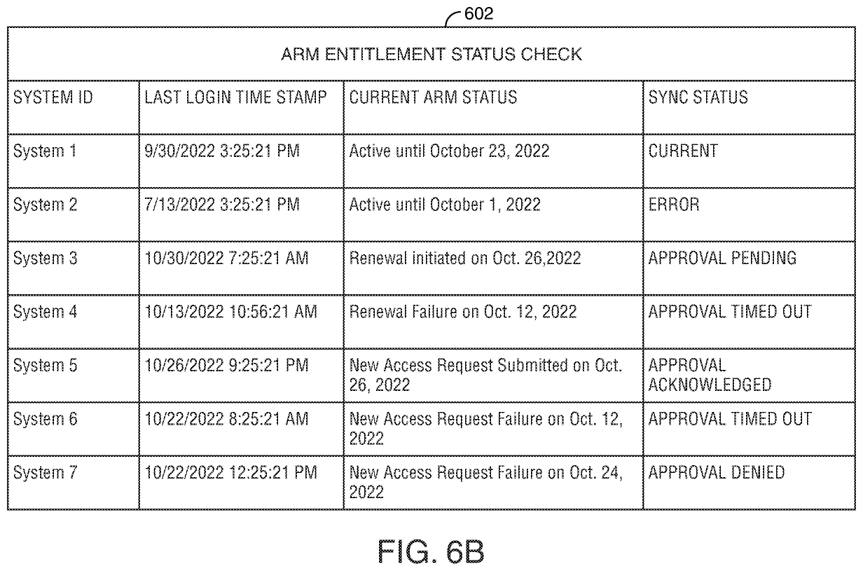

FIG. 6A shows illustrative screenshot 601 of user interface 505 (described in connection with functionalities 500, shown above in FIG. 5). Screenshot 601 shows illustrative features and functionality for viewing, changing and maintaining entitlements of user 101a.

Screenshot 601 includes My Entitlements 603. My Entitlements 603 shows which of restricted entitlements 111 user 101a has credentials for accessing. Screenshot 601 shows AI token status indicator 605. Status indicator 605 shows whether user 101a has authorized autonomous logins by AI engine 201 (e.g., using tokens 303 and 305 described above in connection with FIG. 3). Status indicator 605 shows that user 101a has authorized autonomous logins.

Screenshot 601 shows other users that provide “backup” access 609 to one or more of restricted entitlements 111 on behalf user 101a. For example, backup access 609 shows that User 2 has secondary access to System 2 on behalf of user 101a. Backup access 609 also shows when credentials for each backup user will expire. For example, backup access 609 shows that credentials of User 3 for accessing System 1 will expire on Nov. 2, 2022.

Screenshot 601 shows control button 611 for assigning entitlements. User 101a may click control button 611 to assign backup permission to additional users. Screenshot 601 shows control button 613 for renewing an expired entitlement credentials. Clicking control button 613 may submit a request to ARM server 105 requesting to renew expired credentials for accessing one or more of restricted entitlements 111.

Screenshot 601 shows control button 615 for revoking access to an entitlement. For example, user 101a may click control button 615 to revoke access to an entitlement from one or more users that current have credentials for providing backup access 609. Screenshot 601 includes control button 617 for user 101a to request access to a new entitlement. For example, My Entitlements 603 may show that currently user 101a does not have access to Systems 5, 6 or 7. User 101a may click control button 617 to request credentials for accessing Systems 5, 6 or 7.

Screenshot 601 also shows control button 619 for adding expiration dates to a calendar program. User 101a may click control button 619 and add expiration dates determined by AI engine 201 to a program user 101a uses regularly for scheduling daily meetings or other tasks. Adding expiration dates to such a calendar program may allow user 101a to receive information from AI engine 201 via the same calendar program user 101a interacts with daily. For example, via integration of AI engine 201 with the calendar program, user 101a may receive reminders about upcoming expiration dates, login reminders and requests for authorization to perform autonomous logins via the same calendar program user 101a interacts with daily.

FIG. 6B shows illustrative screenshot 602 showing illustrative features of user interface 505 (described in connection with functionalities 500, shown above in FIG. 5). Screenshot 602 shows illustrative features and functionality for viewing, changing and maintaining entitlements of user 101a.

Screenshot 602 shows whether a status of credentials registered with ARM server 105 is in sync with a status of those credentials as determined by AI engine 201. For example, with respect to System 2, My Entitlements 603 shows that AI engine 201 expects credentials of user 101a for accessing System 2 to expire on Nov. 2, 2022. On the other hand, screenshot 602 shows that ARM server 105 expects the credentials of user 101a for accessing System 2 will expire on Oct. 23, 2022. To synchronize the expected expiration dates, user 101a may click control button 613 to force a refresh of entitlement data maintained by ARM server 105.

Screenshot 602 shows a status of a request by user 101a to renew credentials for accessing System 3. Screenshot 602 shows that a renewal request associated with System 3 has been initiated, is currently in progress and is awaiting approval from ARM server 105. Screenshot 602 shows that user 101a has requested renewal of credentials for accessing System 4. Screenshot 602 also shows that the renewal request associated with System 4 has timed out.

AI engine 201 may autonomously re-submit the System 4 renewal request at least once within a predetermined interval (e.g., within 24 hours of the time out). AI engine 201 may determine whether to resubmit a renewal request based on a sync status associated with the failed request. For example, if the renewal request fails because of a “time out,” AI engine 201 may autonomously resubmit the renewal request. However, if the renewal request fails because of a denial, then AI engine 201 may not autonomously resubmit the request. If the renewal request fails because of a denial, user 101a may be required to manually resubmit the request using control button 617.

Screenshot 602 shows that user 101a has submitted a new access request for credentials to access System 5. Screenshot 602 shows that the new request for access to System 5 has been acknowledged by ARM server 105. Screenshot 602 shows that user 101a has submitted a new access request for credentials to access System 6 and that this request has timed out. AI engine 201 may autonomously resubmit the new request for access to System 6. For example, the new request for access to System 6 may have timed out as a result of network congestion or ARM server 105 receiving a large number of concurrent access or renewal requests.

Screenshot 602 shows that user 101a has submitted a new request for credentials to access System 7. Screenshot 602 shows that the new request for access to System 7 has been denied by ARM server 105. User 101a will receive a notification (e.g., email or text message) that the request for access to System 7 has been denied. User 101a may intervene manually using control button 617 to submit a new request for access to System 7. AI engine 201 may monitor user access requests and only allow user 101a to resubmit a threshold number of requests after a denial or time out via user interface 505.

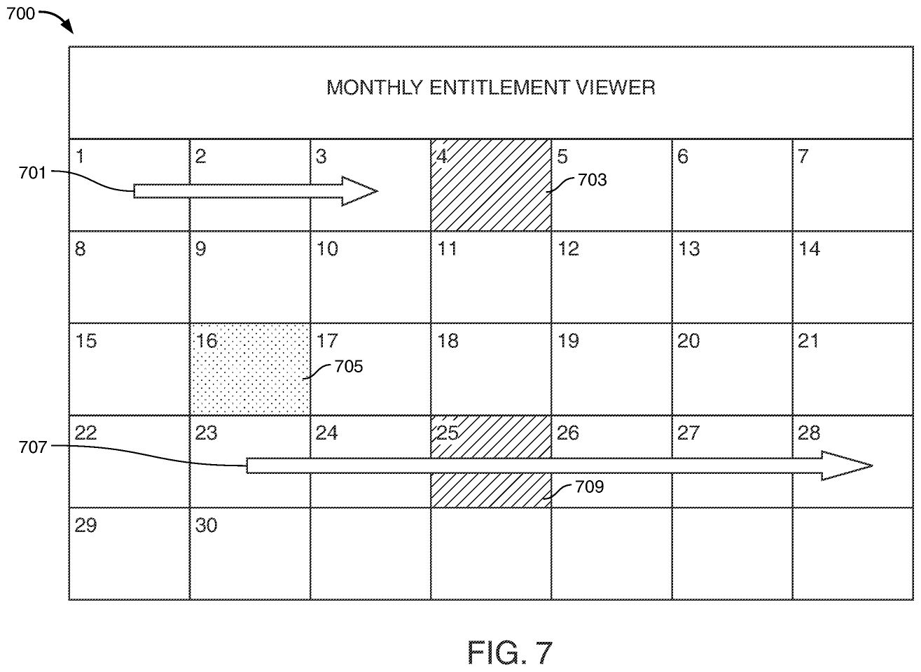

FIG. 7 shows illustrative monthly calendar view 700. Calendar view 700 may be generated by clicking control button 619 and linking AI engine 201 with calendar application 207 (shown in FIG. 2). View 700 shows that based on entitlement information (e.g., My Entitlements 603, shown above in FIG. 6) calendar application 207 may display expiration dates overlayed on work schedules of users 101.

For example, at 701, calendar view 700 shows that user 101b expects to be out-of-office from the 1^{st} through the 3^{rd} of a month. Calendar view 700 also shows that credentials of user 101b for accessing restricted entitlements 111 are expected to expire on the 4^{th} day of the month. Based on information presented in calendar view 700, user 101b may take necessary steps to ensure that access to restricted entitlements 111 is maintained before leaving on the 1^{st} day of the month. In some embodiments, based on information in calendar view 700, AI engine 201 may take steps to obtain authorization from user 101b to autonomously log into restricted entitlements before user 101b leaves on the 1^{st}.

Calendar view 700 also shows expiration date 705 of credentials of user 101b to access another one of restricted entitlements 111. Because expected expiration date 705 is well after user 101b returns to the office, AI engine 201 may not take any action regarding expiration date 705 until after user 101b returns to the office on the 3^{rd} day of the month. Calendar view 700 shows that user 101a will be out of the office during time window 707. User 101a may provide secondary or proxy access on behalf of user 101b. Calendar view 700 shows that expiration date 709 of user 101b credentials is expected to occur during time window 707 while user 101a is out of the office. User 101b may assign another one of users 101 with secondary or proxy access such that at least one of users 101 has secondary or proxy access during time window 707.

Thus, methods and apparatus for a DYNAMIC ENTITLEMENT MANGAGEMENT AND CONTROL are provided. Persons skilled in the art will appreciate that the present disclosure can be practiced by other than the described embodiments, which are presented for purposes of illustration rather than of limitation, and that the present disclosure is limited only by the claims that follow.

What is claimed is:

1. An artificial intelligence (“AI”) method for dynamically managing entitlements, the method comprising extracting computer readable instructions stored on a non-transitory medium and executing the computer readable instructions on a processor, wherein execution of the computer readable instructions by the processor:
detects a first login by a user to access a target entitlement;
based on the first login, determines an expiration date when the user will lose access to the target entitlement;
based on the expiration date, schedules a target date for effectuating a second login needed to maintain access to the target entitlement after the expiration date; and
before the target date, initiates the second login to the target entitlement.

2. The AI method of claim 1, wherein the execution of the computer readable instructions by the processor:
detects a third login to the target entitlement after the first login and before the target date; and
in response to detecting the third login:
determines a revised expiration date and a revised target date; and
reschedules the second login for a time after the expiration date and before the revised target date.

3. The AI method of claim 1, wherein the execution of the computer readable instructions by the processor:
detects an assignment of a proxy to access the target entitlement on behalf of the user; and
before the target date, initiates a third login to the target entitlement on behalf of the proxy.

4. The AI method of claim 1, wherein the target entitlement is a first target entitlement and the execution of the computer readable instructions by the processor:
determines a time window when the user must login to the first target entitlement and a second target entitlement to maintain access to the first target entitlement and to the second target entitlement; and
during the time window:
initiates the second login to the first target entitlement using first credentials; and
initiates a third login to the second target entitlement using second credentials.

5. The AI method of claim 1, wherein access to functionality provided by the target entitlement requires two-factor authentication and access to the target entitlement via the second login only maintains access of the user to the target entitlement after the expiration date not request and does not require two-factor authentication.

6. The AI method of claim 5, wherein the execution of the computer readable instructions by the processor:
detects initiation of a threshold number of initiations of the second login; and
on the target date, presents a login screen that requires two-factor authentication.

7. The AI method of claim 3, wherein the execution of the computer readable instructions by the processor effectuates the assignment of the proxy based on a frequency of email correspondence between the user and the proxy.

8. The AI method of claim 1, wherein the execution of the computer readable instructions by the processor determines the expiration date based on a first time zone associated with the target entitlement and a second time zone associated with the user.

9. The AI method of claim 1, wherein the execution of the computer readable instructions by the processor:
after initiating the second login and after the expiration date, queries an access a central rights management system for a timestamp of a most recent entitlement update for the user; and
if the timestamp indicates that the most recent entitlement update was before the second login, then submits a request to renew access to the target entitlement.

10. An artificial intelligence (“AI”) system for managing entitlements for a user, the system comprising:
an AI engine that determines:
a plurality of entitlements associated with the user;
a level of access that is needed by the user for each of the plurality of entitlements;
an expiration date for each of the plurality of entitlements; and
based on the expiration date for each of the plurality of entitlements, formulate a target date for accessing each of the plurality of entitlements and thereby maintaining access to the plurality of entitlements; and
a user interface that allows the user to:
assign a proxy to access the entitlement;
search for a target entitlement;
submit a request for access to the target entitlement; and
authorize the AI engine to effectuate access to each of the plurality of entitlements before the expiration date for each of the plurality of entitlements.

11. The AI system of claim 10, wherein the AI engine:
prompts the user for a first set of credentials via the user interface; and
in response to authenticating the first set of credentials, formulates, using a second set of credentials, a login request for each of the plurality of entitlements before the expiration date for each of the plurality of entitlements.

12. The AI system of claim 11, wherein:
a first login request formulated by the AI engine for at least one of the plurality of entitlements provides a first level of access to an underlying software resource; and
a second login request formulated by the user for the at least one of the plurality of entitlements provides a second level of access to the underlying software resource.

13. The AI system of claim 10, wherein:
the first set of credentials comprises a token stored locally on a device of the user; and
the second set of credentials comprises credentials for each of the plurality of entitlements.

14. The AI system of claim 10, wherein:
the first set of credentials comprises a token stored locally on a device of the user; and
the second set of credentials comprises credentials manually entered by the user.

15. The AI system of claim 10 wherein the AI engine:
after the expiration date for each of the plurality of entitlements, attempts to access each of the plurality of entitlements using the second set of credentials; and
in response to receiving a failure to access at least one of the plurality of entitlements, submits a request to an access rights management system for access to the at least one of the plurality of entitlements.

16. The AI system of claim 10, wherein the user interface allows the user to:
search for co-workers that have access to a target entitlement;
revoke the proxy from a first co-worker; and
reassign the proxy to a second co-worker.

17. The AI system of claim 10, wherein the user interface allows the user to:
assign the proxy based on an out-of-office reply set by the user; and
revoke the proxy based on the out-of-office reply.

18. A system architecture for managing entitlements of users, the system architecture comprising:
a first restricted entitlement;
a second restricted entitlement;
a user interface that presents:
primary access rights of a first user to the first restricted entitlement;
secondary access rights of the first user to the second restricted entitlement; and
proxy access rights of a second user to the first restricted entitlement; and
an artificial intelligence (“AI”) engine that maintains:
the primary access rights and the secondary access rights of the first user; and
the proxy access rights of the second user.

19. The system architecture of claim 18 further comprising a plugin that integrates the user interface into:
a first virtual assistant application of the first user; and
a second virtual assistant application of the second user.

20. The system architecture of claim 18 wherein, the AI engine autonomously logins into the first restricted entitlement and second restricted entitlement to maintain:
the primary access rights and the secondary access rights of the first user; and
the proxy access rights of the second user.
